(19) United States
(12) Patent Application Publication
(10) Pub. No.: US 2026/0080491 A1
(43) Pub. Date: Mar. 19, 2026

(54) METHOD, SERVER, AND SYSTEM FOR EXPLORING PERSONALIZED CAREER PATHS USING GAMIFICATION

(71) Applicant: SaJaGaOnDa Co.,Ltd., Gyeonggi-do (KR)

(72) Inventors: Minjae LEE, Gyeonggi-do (KR); Byungmin LEE, Gyeonggi-do (KR); Joohee LEE, Seoul (KR); Hyeyeon JO, Incheon (KR)

(21) Appl. No.: 19/279,246

(22) Filed: Jul. 24, 2025

(30) Foreign Application Priority Data
Sep. 13, 2024 (KR) 10-2024-0125396

(51) Int. Cl. G06Q 50/20; A63F 13/67

(52) U.S. Cl. CPC G06Q 50/205; A63F 13/67

(57) ABSTRACT

A method, server, and system for exploring personalized career paths based on gamification by a career exploration server. The method includes accumulating career information regarding at least one of a user's tendencies, aptitudes, and preferences in a stepwise manner through survey conducted in a pre-prepared question-and-answer format to support the user's career exploration, generating, at a specific point in time during the survey, gamified situational elements related to career information that affects following process of the survey by a generative artificial intelligence model based on the accumulated career information, providing a gamified simulation to test user's ability to respond to each situation based on the generated gamified situational elements, and verifying user's accumulated career information based on results of the gamified simulation, and composing the following process of the survey based on verification results.

### CROSS-REFERENCE TO RELATED APPLICATION

This application claims priority to and the benefit of Korean Patent Application No. 10-2024-0125396, filed on Sep. 13, 2024, the disclosure of which is incorporated herein by reference in its entirety.

### BACKGROUND

### 1. Field of the Invention

Various embodiments of the present invention relate to a method, server, and system for exploring a user's career path, and more particularly, to a method, server, and system for exploring a user's career path by assessing performance capabilities in various career exploration processes.

### 2. Discussion of Related Art

Conventional career exploration methods were primarily conducted through face-to-face counseling, during which users assessed their aptitudes and interests using psychological tests, aptitude tests, and vocational personality assessments to explore their career paths.

These career exploration methods evolved to identify a user's basic tendencies and recommend suitable occupations, but they relied heavily on standardized procedures and questions, limiting their ability to fully reflect individual user characteristics.

As an alternative, with the advancement of the internet, online career exploration platforms have emerged, enabling users to engage in various forms of career exploration. These platforms have significantly improved information accessibility by providing personality tests and job-related information online. However, such platforms were primarily limited to user-driven information searches, lacking interactive elements or personalized experiences.

Meanwhile, gamification technology, which has recently gained attention, has evolved as a method to enhance user engagement and motivation by applying game elements to non-game environments. This gamification technology has been utilized in various fields, such as marketing and healthcare, to make user experiences more engaging and immersive.

However, such gamification technology has primarily been applied to areas other than career exploration. Consequently, there have been limitations in providing diverse game-like experiences to test a user's career selection process in the context of career exploration.

Examples of the related art include Korean Registered Patent No. 10-2630810 (Registered date: Jan. 24, 2024)

### SUMMARY OF THE INVENTION

To address the aforementioned issues, the present invention aims to provide a method, server, and system for exploring personalized career paths using gamification. The invention enables users to optimally select their career paths at critical decision points through simulations utilizing gamified situational elements.

To achieve the objectives of the present invention, a method according to an embodiment relates to a method for exploring personalized career paths based on gamification by a career exploration server. The method includes accumulating career information regarding at least one of a user's tendencies, aptitudes, and preferences in a stepwise manner through survey conducted in a pre-prepared question-and-answer format to support the user's career exploration, generating, at a specific point in time during the survey, gamified situational elements related to career information that affects following process of the survey by a generative artificial intelligence model based on the accumulated career information, providing a gamified simulation to test user's ability to respond to each situation based on the generated gamified situational elements, and verifying user's accumulated career information based on results of the gamified simulation, and composing the following process of the survey based on verification results.

In one embodiment, verifying user's accumulated career information may include determining whether there is a correlation between results of the gamified simulation and the user's accumulated career information, and providing feedback to adjust the user's accumulated career information based on determination results.

In one embodiment, providing the gamified simulation may include generating at least one job scenario in which the user can respond to the generated gamified situational elements, and evaluating the user's job success potential and suitability by simulating the generated at least one job scenario.

In one embodiment, the specific point in time may be a moment when inconsistencies arise among the accumulated career information or when career information misaligned with the user's tendencies is obtained.

In one embodiment, the specific point in time may be as a branching point at which user's selectable career paths diverge based on the accumulated career information.

As described above, various embodiments of the present invention enable users to make critical decisions at key career crossroads through gamified situational elements. By simulating in real-time how well these decisions align with the user's tendencies and aptitudes, the invention significantly enhances the accuracy and satisfaction of career choices.

Additionally, various embodiments of the present invention can add enjoyment and immersion to the career exploration process through gamification, thereby reducing user fatigue and encouraging sustained engagement.

Moreover, various embodiments of the present invention can analyze the correlation between simulation results and accumulated career information to verify whether the user is exploring a career in the wrong direction or whether the career information is being correctly accumulated. This allows the provision of feedback for users to continuously refine and optimize their career information.

Furthermore, various embodiments of the present invention enable the evaluation of a user's practical suitability for a specific job through generated job scenarios. This goes beyond theoretical suitability assessments, allowing evaluation of real-world response capabilities, enabling more practical career exploration, and predicting job success potential based on simulation results, thereby providing users with more specific career-related predictive information.

Additionally, various embodiments of the present invention automatically detect inconsistencies in accumulated career information or career information misaligned with the user's tendencies, reflecting these in subsequent surveys. This helps prevent users from pursuing incorrect career paths, reduces errors in the career exploration process, and enhances the reliability of the career exploration process.

Moreover, various embodiments of the present invention detect moments when selectable career paths diverge, guiding users to make optimal choices at critical decision points. This helps users establish clear directionality in their career choices, reducing the likelihood of making incorrect decisions.

The effects mentioned above are not exhaustive, and other effects not mentioned will be clearly understood by those skilled in the art from the description below.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a diagram illustrating a career exploration system according to an embodiment of the present invention.

FIG. 2 is a diagram specifically illustrating the configuration of the career exploration server of FIG. 1 according to an embodiment of the present invention.

FIG. 3 is a diagram specifically illustrating the configuration of the career information verification unit of FIG. 2 through correlation analysis according to an embodiment of the present invention.

FIG. 4 is a diagram specifically illustrating the configuration of the career information verification unit of FIG. 2 for simulating job scenarios to evaluate a user's job success potential and suitability according to an embodiment of the present invention.

FIG. 5 is a diagram illustrating a different configuration of the career exploration server from that of FIG. 2 according to an embodiment of the present invention.

FIG. 6 is a flowchart illustrating a method for exploring personalized career paths using gamification according to an embodiment of the present invention.

FIG. 7 is a flowchart illustrating a method for verifying a user's career information in step S130 through correlation analysis according to an embodiment of the present invention.

FIG. 8 is a flowchart specifically illustrating step S130 for simulating job scenarios to evaluate a user's job success potential and suitability according to an embodiment of the present invention.

### DETAILED DESCRIPTION OF EXEMPLARY EMBODIMENTS

The embodiments described in this specification and the configurations shown in the drawings are merely preferred examples of the disclosed invention, and various modifications that can replace the embodiments and drawings of this specification may exist at the time of filing this application. The same reference numerals or symbols presented in each drawing indicate components or elements that perform substantially the same function.

Additionally, the suffixes “unit” or “module” used for components in the description of this specification are assigned or used interchangeably for ease of drafting the specification and do not inherently have distinct meanings or roles. Furthermore, the “unit” or “module” includes units realized by hardware, units realized by software, or units realized by a combination of both. Additionally, a single unit may be realized using two or more pieces of hardware, or two or more units may be realized by a single piece of hardware.

In this specification, expressions such as “A and/or B” or “at least one of A and B” refer to all possible combinations of the listed items. Terms including ordinals, such as “first” and “second,” may be used to describe various components, but these components are not limited by such terms. These terms are used solely to distinguish one component from another.

Furthermore, terms such as “include” or “may include” in this specification are intended to specify the presence of features, numbers, steps, operations, components, parts, or combinations thereof described in the specification, but do not preclude the presence or addition of one or more other features, numbers, steps, operations, components, parts, or combinations thereof.

Additionally, the terms used in this specification are merely employed to describe specific embodiments and are not intended to limit the scope of other embodiments. Singular expressions may include plural expressions unless the context clearly indicates otherwise. All terms used herein, including technical or scientific terms, may have the same meaning as commonly understood by those skilled in the art of the present disclosure. Terms defined in general dictionaries may be interpreted as having the same or similar meanings as those in the context of the relevant technology, and unless explicitly defined in this application, they are not interpreted in an idealized or overly formal sense. In some cases, even terms defined in this application cannot be interpreted to exclude embodiments of the present disclosure.

Hereinafter, preferred embodiments of the present disclosure will be described in more detail with reference to the drawings.

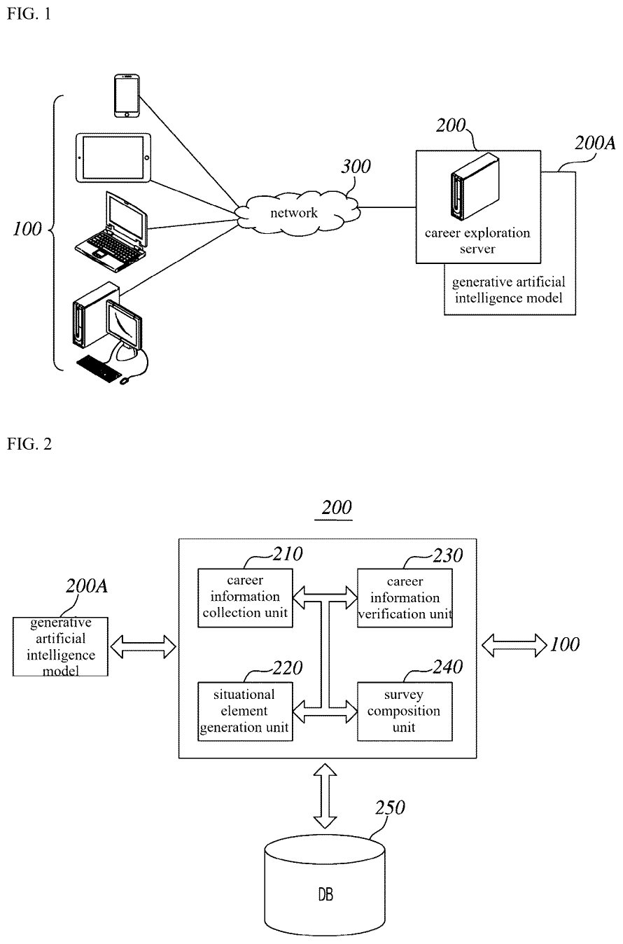

FIG. 1 is a diagram illustrating a career exploration system according to an embodiment of the present invention.

Referring to FIG. 1, a career exploration system according to an embodiment includes a user terminal (100), a career exploration server (200), and a network (300).

In one embodiment, the user terminal (100) is a user interface device through which a user accesses and interacts with the career exploration server (200). To provide a user interface for accessing the career exploration server (200), the user may create a new account to log in and initiate the exploration process. This user interface is designed to provide an intuitive user experience and may include menus and exploration tools for navigating various career options.

Furthermore, the user terminal (100) allows the user to respond to staged surveys as the initial step of career exploration. The user responds to various questions regarding their tendencies, aptitudes, and preferences, and these responses can be transmitted to the career exploration server (200) in real-time for accumulation. Through this process, the user can input and update various information necessary for career exploration.

Additionally, the user terminal (100) may execute gamification elements and simulations generated by the career exploration server (200). For example, the user can play a simulation game based on virtual job scenarios to test their ability to respond to specific job situations. Thus, the user terminal (100) can record the user's actions and choices during the simulation process, which can be used to verify accumulated career information.

Moreover, the user terminal (100) according to an embodiment can receive real-time feedback from the career exploration server (200) based on the information input by the user and the simulation results. That is, when feedback is transmitted from the career exploration server (200), the user terminal (100) immediately displays it on the screen, allowing the user to receive guidance on which aspects of their career exploration process need revision or improvement. This feedback plays a critical role in enhancing the accuracy of the user's career exploration.

Within these processes, the user terminal (100) can exchange data with the career exploration server (200) in real-time via the network (300). For example, survey responses, simulation results, and other career-related information input by the user are stored in the career exploration server (200) through the network (300). Data and feedback processed by the career exploration server (200) are transmitted back to the user terminal (100) via the network (300) and displayed on the screen. During this process, the user terminal (100) synchronizes data to enable the user to continue career exploration with the latest information anytime, anywhere.

Although the user terminal (100) is described in the singular, it is undoubtedly a plurality of user terminals (100) when multiple users are involved. To perform their unique functions, the user terminal may be any of a personal computer (PC; e.g., desktop computer, laptop or notebook computer, tablet computer), smartphone (e.g., iOS, Android, Windows Phone), mobile phone or feature phone, internet-connected smart TV, wearable device, IoT (Internet of Things) device, or browser device capable of wired or wireless communication, but is not necessarily limited thereto.

In one embodiment, the career exploration server (200) may perform the function of collecting data provided by the user during the career exploration process and systematically accumulating it. To this end, the career exploration server (200) may provide survey information in a staged question-and-answer format to the user terminal (100) via the network (300) for the user's career exploration.

At this time, the survey information plays a significant role in the career exploration process and may consist of various questions to comprehensively analyze the user's tendencies, aptitudes, preferences, and experiences.

As a result, the user responds to surveys regarding tendencies, aptitudes, preferences, and experiences through the user terminal (100) in a staged manner, and these responses can be transmitted to the career exploration server (200) in real-time. Accordingly, the career exploration server (200) can accumulate career information related to the user's tendencies, aptitudes, and preferences based on the received data and store it for use in subsequent career exploration processes.

At this point, career information related to the user's tendencies, aptitudes, and preferences may, for example, relate to university major choices but is not limited thereto and may include career paths for job selection or university admission, indicating that the career exploration process can span various fields.

Furthermore, the career exploration server (200) may utilize a generative artificial intelligence model (200A) at specific points in time during the career exploration process to generate gamified situational elements based on the accumulated career information. In this process, the career exploration server (200) can identify specific career information that significantly impacts the user's career exploration and design gamified scenarios or simulations that allow the user to experience job situations based on this information.

At this time, the gamified situational elements can support a more precise evaluation of the user's career suitability.

Here, the generative artificial intelligence model (200A) can design virtual situational elements that the user can realistically experience based on the accumulated career information. In this process, the generative artificial intelligence model (200A) can create realistic scenarios by reflecting tasks, challenges, or problem situations related to specific academic disciplines or occupations. For example, it can construct virtual scenarios for research projects or job situations in specific fields.

The generative artificial intelligence model (200A) can perform the task of converting designed virtual situations into gamified formats. In this process, it can add challenges, scoring systems, and reward mechanisms to implement gamified situational elements that the user can engage with, and it can set detailed variables and conditions within the gamified situations. Additionally, the generative artificial intelligence model (200A) can configure dynamic elements that allow situations to change based on the user's responses, enabling the user to experience various scenarios.

Additionally, in one embodiment, the career exploration server (200) provides simulations that the user can participate in based on the generated gamified situational elements to the user terminal (100) via the network (300) and can verify the user's accumulated career information by analyzing the simulation results.

For example, when a user participates in a simulation to test their response capabilities in specific job situations, the career exploration server (200) can collect and analyze this data to determine its correlation with the career information previously provided by the user. This allows the server to assess whether the user's career information is being appropriately accumulated or requires modification.

Furthermore, the career exploration server (200) can verify the user's career information based on the simulation results and, if necessary, generate real-time feedback to provide to the user. The provided feedback can offer specific guidance on which aspects of the career exploration process the user needs to revise or improve.

As a result, the career exploration server (200) can adjust or update the user's career information through feedback. This process helps the user conduct more accurate and personalized career exploration.

Moreover, the career exploration server (200) can handle specific points in time that may arise during the accumulation of the user's career information. For example, when inconsistencies arise among the accumulated career information or when career information misaligned with the user's tendencies is detected, the career exploration server (200) can identify these issues and take appropriate actions. Additionally, at points in time where selectable career paths diverge, the server can provide additional information or propose new surveys to help the user make optimal decisions.

As such, the career exploration server (200) according to an embodiment processes several essential functions as described above to support a personalized career exploration process, playing a critical role in enhancing the overall efficiency of the system and user satisfaction.

Additionally, the career exploration server (200) can analyze the user's response patterns in real-time to dynamically adjust gamified situational elements when inconsistencies or contradictions arise with previous choices. It can also provide visualized compatibility between the user's chosen career path and the required tendencies and aptitudes to the user terminal (100), helping the user re-evaluate or revise their career choices.

Furthermore, when inconsistencies or misalignments in tendencies are detected, the career exploration server (200) can provide additional question-and-answer games to analyze the cause of the inconsistencies and offer further information to resolve them to the user terminal (100). Based on the user's past choices, it can customize job scenarios using real-world cases of individuals with similar tendencies and provide them to the user. Additionally, by comparing with previous choices, it can evaluate the variability of career choices and, in cases of high variability, offer additional simulation opportunities to the user terminal (100) to allow the user to explore various options.

In one embodiment, the network (300) may include a wired network or a wireless network connecting the user terminal (100) and the career exploration server (200).

For example, if the network (300) is a wireless network, the wireless network may include at least one of, for example, LTE (Long-Term Evolution), LTE-A (LTE Advance), CDMA (Code Division Multiple Access), WCDMA (Wideband CDMA), UMTS (Universal Mobile Telecommunications System), WiBro (Wireless Broadband), WiFi (Wireless Fidelity), Bluetooth, NFC (Near Field Communication), and GNSS (Global Navigation Satellite System).

On the other hand, if the network (300) is a wired network, the wired network may include at least one of, for example, USB (Universal Serial Bus), HDMI (High Definition Multimedia Interface), RS-232 (Recommended Standard), LAN (Local Area Network), WAN (Wide Area Network), the Internet, and a telephone network. However, the type of network (300) is not necessarily limited thereto.

FIG. 2 is a diagram specifically illustrating the configuration of the career exploration server of FIG. 1 according to an embodiment of the present invention.

Referring to FIG. 2, the career exploration server (200) according to an embodiment may include a career information collection unit (210), a situational element generation unit (220), a career information verification unit (230), a survey composition unit (240), and a database (250) to explore personalized gamification-based career paths.

In one embodiment, the career information collection unit (210) may gradually accumulate career information regarding at least one of a user's tendencies, aptitudes, and preferences through staged surveys to support the user's career exploration, such as university major selection.

To this end, the career information collection unit (210) may provide a first survey related to university major selection to the user terminal (100) to collect information about the user's tendencies. For example, through a question such as “In what environment do you feel most comfortable when learning?” the unit may ask whether the user feels most comfortable in a laboratory research setting, theoretical classroom learning, group discussions, or independent research. If the user responds with “theoretical classroom learning,” the career information collection unit (210) may store this response as data representing the user's tendencies in the database (250).

Additionally, the career information collection unit (210) may provide a second survey to the user terminal (100) to obtain information about the user's aptitudes. For example, through a question such as “In which subject do you feel a greater sense of achievement?” the unit may ask whether the user feels a greater sense of achievement in mathematics, physics, biology, or literature. If the user responds with “mathematics,” the career information collection unit (210) may store this information as aptitude data in the database (250) and update it along with the previously collected tendency information in the database (250).

Furthermore, the career information collection unit (210) may provide a third survey to the user terminal (100) to collect information about the user's preferences. For example, through a question such as “Which university major are you more interested in?” the unit may ask whether the user is more interested in engineering, humanities, social sciences, or arts. If the user responds with “engineering,” the career information collection unit (210) may store this information as preference data in the database (250), integrating it with previously collected tendency and aptitude information to accumulate career information in a staged manner.

As such, the career information collection unit (210) can provide foundational data to help users better understand their career choices and select suitable university majors.

In one embodiment, the situational element generation unit (220) may generate gamified situational elements related to career information that affects following process of the survey, based on the accumulated career information, using a generative artificial intelligence model (200A) at specific points in time during the survey process.

To this end, the generative artificial intelligence model (200A) may first analyze the tendency, aptitude, and preference data collected by the career information collection unit (210). For example, if a user prefers “theoretical classroom learning,” feels a high sense of achievement in “mathematics,” and is interested in “engineering,” the situational element generation unit (220) may design gamified situational elements suitable for the user based on this information. For instance, if the user is interested in engineering, it may design situational elements including engineering-related tasks.

The designed situational elements may be structured as virtual engineering projects, allowing the user to solve problems. For example, the user may test their problem-solving skills and creativity through a game involving “designing a robot and solving problems.”

The situational element generation unit (220) may add gamified elements to the generated situational elements. For example, it may assign points when the user solves specific problems or add challenges to encourage user participation. These elements may include challenge difficulty levels, scoring systems, and reward mechanisms. Through this, users can evaluate their suitability while experiencing real job situations in a gamified environment.

Furthermore, the situational element generation unit (220) may dynamically adjust the gamified situations based on the user's responses and actions. For example, if the user provides quick and accurate responses during problem-solving, the unit may increase the difficulty of the next problem or add different challenges to more thoroughly evaluate the user's suitability. In this process, the situational element generation unit (220) may set variables and conditions for the situational elements and generate gamified situational elements reflecting these.

As such, the situational element generation unit (220) supports more realistic and systematic career exploration through the aforementioned process. The gamified situational elements can contribute to helping users confirm their aptitudes and interests at specific points and provide critical information for selecting suitable university majors. Meanwhile, the specific point in time at which the survey is conducted may be a moment when inconsistencies arise among the accumulated career information or when career information misaligned with the user's tendencies is obtained.

Thus, at this specific point, the generative artificial intelligence model (200A) may analyze the accumulated career information to identify anomalies. For example, if a user initially responds that they “prefer theoretical learning” but later indicates a preference for “experiments” in subsequent surveys, the situational element generation unit (220) can detect this contradiction. Similarly, if the user shows high aptitude in mathematics but later expresses a strong artistic inclination, the generative artificial intelligence model (200A) can identify this inconsistency.

Upon detecting such contradictions or misaligned information, the generative artificial intelligence model (200A) may consider it a specific point in time and generate adjustments for following process of the survey or additional gamified situational elements to guide the user toward providing more consistent career information. For example, it may take measures to improve the accuracy of the user's career information through additional surveys or feedback.

On the other hand, the specific point in time at which the survey is conducted may also be a moment as a branching point when selectable career paths diverge from the accumulated career information.

For example, if a user shows strong interest and aptitude in the engineering field through tendency, aptitude, and preference surveys, the generative artificial intelligence model (200A) may create a branching point for selectable engineering-related majors or job fields at this point.

For instance, if a user responds that they prefer mathematical aptitude and theoretical learning, the generative artificial intelligence model (200A) may branch into various subfields of engineering (e.g., mechanical engineering, electrical engineering, computer engineering) based on this information.

At such branching points, the generative artificial intelligence model (200A) may design gamified situational elements to allow the user to explore various career paths. For example, it may provide virtual projects or scenarios for each engineering field to help the user assess which field is more suitable.

Based on these branching points, following process of the survey may provide additional questions or scenarios tailored to each career path, helping the user gain a deeper understanding of their chosen career and select the optimal path.

Meanwhile, the generative artificial intelligence model described above may be at least one of a rule-based generation model, template-based generation model, story-based generation model, interactive generation model, or parameter-based generation model, but is not necessarily limited thereto.

In one embodiment, the career information verification unit (230) may provide gamified simulations to the user terminal (100) to test the user's ability to respond to each situation based on the gamified situational elements generated by the situational element generation unit (220).

Through this, the user can solve problems and demonstrate their ability to handle job situations within the simulation.

Specifically, the career information verification unit (230) can record and analyze the user's actions and choices in real-time as they participate in the simulation and solve given problems. For example, if a user interested in engineering participates in a “robot design and fabrication” simulation, the career information verification unit (230) can evaluate whether the user collaborates with a team, solves technical problems, and employs creative approaches.

In this process, the user's behaviors, such as problem-solving skills, collaboration abilities, and creative approaches demonstrated in the simulation, are stored as simulation results. Subsequently, the career information verification unit (230) can perform a verification process by comparing these simulation results with the user's accumulated career information. In other words, it determines whether the performance shown in the simulation aligns with the previously accumulated career information (e.g., tendencies, aptitudes, preferences).

For example, if the user demonstrates excellent problem-solving skills and strong team collaboration performance in the robot design simulation, the career information verification unit (230) can provide an analysis to the user terminal (100) indicating that the user is suitable for engineering fields, particularly roles requiring teamwork.

As such, the career information verification unit (230) evaluates the user's career suitability by comparing simulation results with accumulated career information and can adjust or reinforce the career information as needed.

As another example, the career information verification unit (230) can generate simulations based on gamified situational elements reflecting the user's tendencies, aptitudes, and preferences. For instance, if a user is highly interested in engineering and excels in problem-solving, the unit can create simulations incorporating engineering challenges.

Thus, the career information verification unit (230) can provide gamified simulations to the user terminal (100), enabling the user to engage in problem-solving within specific job situations. For example, the user may participate in a simulation themed around “smart home system design.” This simulation involves the user designing a virtual smart home project and solving related problems.

While the user engages in the simulation, the career information verification unit (230) can record the user's actions, decisions, and problem-solving approaches. These records are included in the simulation results and may contain data such as decisions on sensor placement or proposals for improving energy efficiency.

Accordingly, the career information verification unit (230) can receive simulation results from the user terminal (100) and verify them by comparing them with the career information previously provided by the user (e.g., suitability for engineering).

For instance, the career information verification unit (230) can evaluate how well the simulation results align with the accumulated career information to verify the user's career suitability. For example, if the user effectively solves engineering problems in the simulation, this can confirm alignment with existing career information indicating high suitability for engineering.

Therefore, based on the alignment between simulation results and career information, the career information verification unit (230) can adjust or update the accumulated career information. If the simulation results do not align with the career information, the career information verification unit (230) can provide additional analysis or feedback to enhance the accuracy of the information.

Through this process, the career information verification unit (230) analyzes the results of gamified simulations in real-time, verifies the accuracy of the user's career information, and provides personalized career advice, thereby enhancing the reliability of career exploration.

In one embodiment, the survey composition unit (240) can compose following process of the survey based on the verification results of the career information verification unit (230).

For example, if the career information verification unit (230) determines that the user demonstrated excellent performance in technical problem-solving, such as robot design, in a previous simulation and is highly likely to be suitable for engineering fields, the survey composition unit (240) can add specific questions related to engineering to following process of the survey based on these verification results. For instance, questions such as “Are you more interested in mechanical engineering or electrical engineering?” or “Do you feel stronger in software development or hardware design in robotics?” can be newly composed.

As such, the survey composition unit (240) adjusts surveys to collect more detailed career-related information based on previous verification results, thereby supporting the user in exploring their career more accurately.

As another example, if the career information verification unit (230) concludes that the user showed high performance in a creative problem-solving scenario related to arts in a previous simulation and is likely suitable for arts fields, particularly visual arts or design, the survey composition unit (240) can add more specific questions related to arts to following process of the survey based on these verification results. For example, questions such as “Are you more interested in graphic design or painting?” or “Do you prefer digital media or traditional media?” can be composed.

Thus, the survey composition unit (240) composes surveys that reflect previous verification results, enabling more detailed and specific support for the user's career exploration, helping the user clearly understand and select their career path.

In one embodiment, the database (250) not only permanently stores data processed by the career information collection unit (210), situational element generation unit (220), career information verification unit (230), and survey composition unit (240) but also consists of a structured set of information used for searching, managing, and manipulating the stored data.

For example, the database (250) can store data in a table format and provide query languages such as SQL (Structured Query Language) for searching, modifying, deleting, and inserting mapped data. It also supports simultaneous access by administrators to maintain data consistency and structure.

The database (250) may consist of various types, such as relational databases (e.g., MySQL, PostgreSQL, Oracle, SQL Server), NoSQL databases (e.g., MongoDB, Cassandra), or graph databases (e.g., Neo4j), but is not necessarily limited thereto.

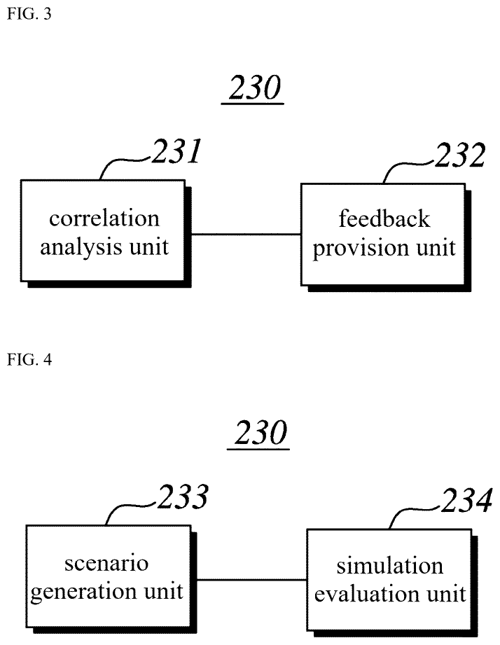

FIG. 3 is a diagram specifically illustrating the configuration of the career information verification unit of FIG. 2 through correlation analysis according to an embodiment of the present invention.

Referring to FIG. 3, the career information verification unit (230) according to an embodiment may include a correlation analysis unit (231) and a feedback provision unit (232).

In one embodiment, the correlation analysis unit (231) can determine the correlation between the performance demonstrated by the user in the simulation and the accumulated career information.

For example, assuming a user participated in a simulation related to “mechanical engineering” and worked on a robot design project, the correlation analysis unit (231) can receive simulation results analyzing the user's problem-solving skills, design techniques, and collaboration abilities from the user terminal (100) and compare these results with the user's accumulated career information to determine the correlation.

At this point, for instance, if the user previously indicated high aptitude and preference for the “mechanical engineering” field in surveys, the simulation performance may be concluded to have a high correlation with this information. However, if the user struggled or showed poor performance during the mechanical engineering project simulation, the correlation analysis unit (231) may consider the possibility that the user may not be suitable for the mechanical engineering field.

Here, correlation analysis is a process of numerically evaluating the relationship between simulation results and the user's accumulated career information, using various specific metrics and scores to quantitatively assess the correlation.

For example, the correlation analysis unit (231) can calculate the success rate of each task performed by the user in the simulation. The success rate is the ratio of the number of problems solved by the user to the total number of problems. For instance, if the user successfully solved 8 out of 10 problems in a robot design simulation, the correlation analysis unit (231) can calculate the success rate as 80%. This success rate can be compared with the user's accumulated career information to determine suitability for the mechanical engineering field.

Additionally, the correlation analysis unit (231) can quantify the user's technical competencies in the simulation. For example, it can assign scores to the user's problem-solving skills, design techniques, and programming abilities, and calculate a technical suitability score by aggregating these scores.

For instance, if the user scores 85 points in problem-solving, 78 points in design techniques, and 80 points in collaboration, the correlation analysis unit (231) can use the average of these scores, 81 points, as the technical suitability score to evaluate suitability for the mechanical engineering field.

Furthermore, the correlation analysis unit (231) can evaluate the alignment between the user's simulation behavior and ideal behavior for the mechanical engineering field. For example, it can compare predefined ideal behavior patterns with the user's actual behavior to assign a score. If the user demonstrates a 70% behavior alignment in the mechanical engineering simulation, this can indicate how well the user's behavior matches the expectations of the mechanical engineering field.

Accordingly, as described above, the correlation analysis unit (231) can calculate a correlation metric by aggregating at least one of the success rate metric, technical suitability score, and behavior alignment score. The calculated correlation metric may numerically represent the degree of alignment between the user's simulation performance and accumulated career information.

For example, to evaluate suitability for the mechanical engineering field, if the success rate metric is 80%, the technical suitability score is 81 points, and the behavior alignment score is 70%, the correlation analysis unit (231) can calculate a correlation score by aggregating these metrics. If the correlation score is, for instance, 0.75 (75%), this may indicate a high correlation between the user's simulation performance and suitability for the mechanical engineering field.

On the other hand, in one embodiment, the feedback provision unit (232) can provide feedback to the user terminal (100) based on the correlation analysis results to adjust the user's accumulated career information.

For example, if the correlation score is high, the feedback provision unit (232) can provide positive feedback indicating that the user is suitable for the mechanical engineering field. If the score is low, it may suggest suitability for other fields.

For instance, if the correlation score is 0.75, indicating high suitability, the user receives feedback confirming their suitability for the mechanical engineering field. If the correlation score is low, such as 0.50, the user may be suggested possibilities in other engineering fields, such as electrical engineering or software engineering.

Such feedback guides the user to select a more suitable career path in the subsequent career exploration process and, if necessary, enables deeper analysis through additional simulations or surveys.

FIG. 4 is a diagram specifically illustrating the configuration of the career information verification unit of FIG. 2 for simulating job scenarios to evaluate a user's job success potential and suitability according to an embodiment of the present invention.

Referring to FIG. 4, the career information verification unit (230) according to an embodiment may further include a scenario generation unit (233) and a simulation evaluation unit (234).

In one embodiment, the scenario generation unit (233) can generate at least one job scenario in which the user can respond to various forms of generated situational elements.

For example, the scenario generation unit (233) may generate a scenario requiring the user to implement a web application's functionality using a new programming language or complex algorithm for situational elements related to technical challenges. It may also generate a scenario where the user collaborates with team members to develop software for situational elements requiring teamwork. Additionally, it may generate a scenario where the user must complete a project within a specified deadline for situational elements related to time management issues.

On the other hand, the simulation evaluation unit (234) according to an embodiment, when the job scenario generated by the scenario generation unit (233) is a web application development project scenario, can obtain the results of simulating this web application development project scenario and evaluate, for example, the accuracy of the code, the completeness of function implementation, and the efficiency of the algorithm.

For instance, in evaluating code accuracy, the simulation evaluation unit (234) can analyze errors in the written code and calculate the error rate relative to the total lines of code. For example, if 20 lines out of 1000 lines of code contain errors, the error rate is calculated as 2%. This rate can be used to assess code accuracy and assign a high accuracy score.

Additionally, in evaluating the completeness of function implementation, the simulation evaluation unit (234) can test how well the implemented functions perform based on the scenario's requirements. The completeness of each function is evaluated on a scale from 0% to 100%. For example, if the user authentication function meets 90% of the requirements, the function completeness score is recorded as 90 points.

Furthermore, in evaluating algorithm efficiency, the simulation evaluation unit (234) can measure the algorithm's execution time and resource usage to assess efficiency. For example, if the average execution time of an algorithm is measured as 5 seconds, an efficiency score of 80 points can be assigned based on this time. The efficiency score reflects optimized performance.

Accordingly, the simulation evaluation unit (234) can quantitatively evaluate the user's job success potential by aggregating these evaluation results. For example, it can calculate an average score from a code accuracy score of 90 points, a function completeness score of 85 points, and an algorithm efficiency score of 80 points, using this as the user's job suitability score.

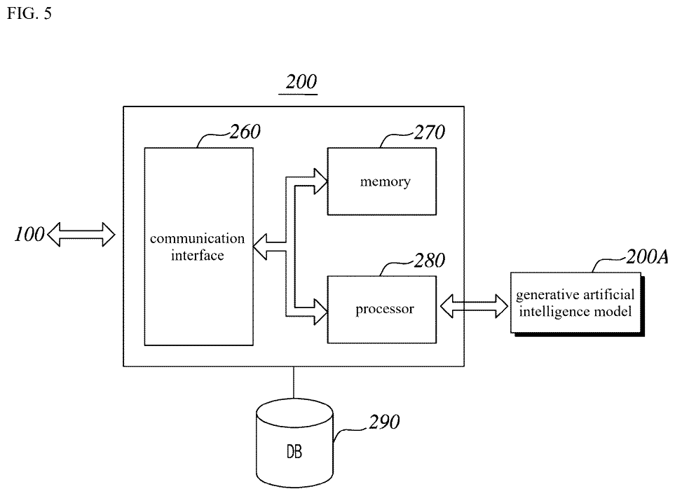

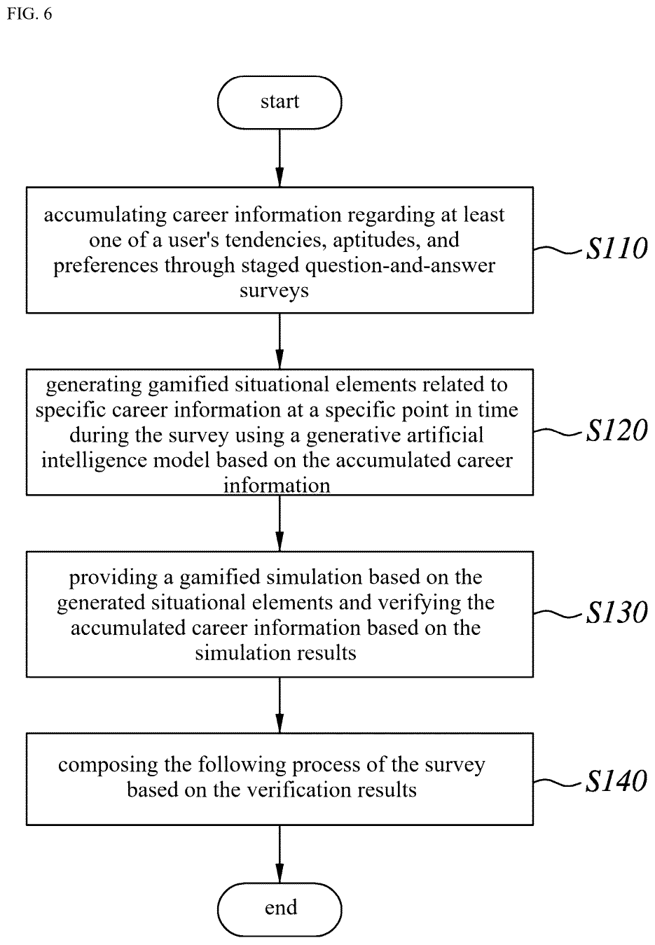

FIG. 5 is a diagram illustrating an alternative configuration of the career exploration server of FIG. 2 according to an embodiment of the present invention.

Referring to FIG. 5, the career exploration server (200) according to an embodiment may include a communication interface (260), a memory (270), a processor (280), and a database (290).

In one embodiment, the communication interface (260) can support a communication interface compatible with the type of network (300) to transmit and receive data to and from the user terminal (100) connected to the network (300). For example, if the network (300) is a wireless network, it provides a communication interface suitable for the wireless network, and if the network (300) is a wired network, it provides a communication interface suitable for the wired network.

In one embodiment, the memory (270) is a storage medium capable of temporarily or partially permanently storing at least one instruction. For example, it may include at least one of Read-Only Memory (ROM) for permanently storing data processed by the processor (280) described below, Random Access Memory (RAM) for temporarily storing data, cache memory, flash memory, or virtual memory, but is not necessarily limited thereto.

At this time, the ROM may include Programmable ROM (PROM), Erasable Programmable ROM (EPROM), and Electrically Erasable Programmable ROM (EEPROM), and the RAM may include Dynamic RAM (DRAM), Static RAM (SRAM), Double Data Rate Synchronous Dynamic RAM (DDR SDRAM), and Low Power DDR (LPDDR), but is not necessarily limited thereto.

In one embodiment, the processor (280) can perform the process of exploring personalized gamification-based career paths by processing at least one instruction stored in the memory (270). The career exploration process has been described above with reference to FIGS. 2 to 4.

The processor (280) may consist of at least one core and may include processors for data analysis and/or processing, such as a Central Processing Unit (CPU), General Purpose Graphics Processing Unit (GPGPU), or Tensor Processing Unit (TPU).

In one embodiment, the database (290) performs the same role as the database (250) described in FIG. 2, and thus its description is omitted.

Hereinafter, the functional operations performed by the processor (280) of the career exploration server (200) will be described in detail.

FIG. 6 is a flowchart illustrating a method for exploring personalized career paths using gamification according to an embodiment of the present invention.

Referring to FIG. 6, the method according to an embodiment, performed by the processor (280) of the career exploration server (200), may include steps S110 to S140 to explore personalized career paths using gamification.

In step S110, the processor (280) can gradually accumulate career information regarding at least one of a user's tendencies, aptitudes, and preferences through staged surveys to support the user's career exploration, such as university major selection.

To this end, the processor (280) may provide a first survey related to university major selection to the user terminal (100) to collect information about the user's tendencies. For example, through a question such as “In what environment do you feel most comfortable when learning?” the processor may ask whether the user feels most comfortable in a laboratory research setting, theoretical classroom learning, group discussions, or independent research. If the user responds with “theoretical classroom learning,” the processor (280) may store this response as data representing the user's tendencies in the database (290).

Additionally, in step S110, the processor (280) may provide a second survey to the user terminal (100) to obtain information about the user's aptitudes. For example, through a question such as “In which subject do you feel a greater sense of achievement?” the processor may ask whether the user feels a greater sense of achievement in mathematics, physics, biology, or literature. If the user responds with “mathematics,” the processor (280) may store this information as aptitude data in the database (290) and update it along with the previously collected tendency information in the database (290).

Furthermore, the processor (280) may provide a third survey to the user terminal (100) to collect information about the user's preferences. For example, through a question such as “Which university major are you more interested in?” the processor may ask whether the user is more interested in engineering, humanities, social sciences, or arts. If the user responds with “engineering,” the processor (280) may store this information as preference data in the database (290), integrating it with previously collected tendency and aptitude information to accumulate career information in a staged manner.

In step S120, at a specific point in time during the survey process, the processor (280) may use the generative artificial intelligence model (200A) to generate gamified situational elements related to career information that affects following process of the survey by a generative artificial intelligence model based on the accumulated career information.

To this end, the generative artificial intelligence model (200A) may first analyze the tendency, aptitude, and preference data collected in step S110. For example, if a user prefers “theoretical classroom learning,” feels a high sense of achievement in “mathematics,” and is interested in “engineering,” the generative artificial intelligence model (200A) may design gamified situational elements suitable for the user based on this information. For instance, if the user is interested in engineering, it may design (generate) situational elements including engineering-related tasks.

The designed (generated) situational elements may be structured as virtual engineering projects, allowing the user to solve problems. For example, the user may test their problem-solving skills and creativity through a game involving “designing a robot and solving problems.”

Accordingly, the processor (280) may add gamified elements to the situational elements generated by the generative artificial intelligence model (200A). For example, it may assign points when the user solves specific problems or add challenges to encourage user participation. These added elements may include challenge difficulty levels, scoring systems, and reward mechanisms. Through this, users can evaluate their suitability while experiencing real job situations in a gamified environment.

Furthermore, in step S120, the processor (280) may dynamically adjust the gamified situational elements based on the user's responses and actions. For example, if the user provides quick and accurate responses during problem-solving, the processor may increase the difficulty of the next problem or add different challenges to more thoroughly evaluate the user's suitability.

As such, the processor (280) supports more realistic and systematic career exploration through the aforementioned process. The gamified situational elements can contribute to helping users confirm their aptitudes and interests at specific points and provide critical information for selecting suitable university majors.

Meanwhile, the specific point in time at which the survey is conducted may be a moment when inconsistencies arise among the accumulated career information or when career information misaligned with the user's tendencies is obtained.

Thus, at this specific point, the generative artificial intelligence model (200A) may analyze the accumulated career information to identify anomalies. For example, if a user initially responds that they “prefer theoretical learning” but later indicates a preference for “experiments” in subsequent surveys, the processor (280) can detect this contradiction. Similarly, if the user shows high aptitude in mathematics but later expresses a strong artistic inclination, the generative artificial intelligence model (200A) can identify this inconsistency.

Upon detecting such contradictions or misaligned information, the generative artificial intelligence model (200A) may consider it a specific point and generate adjustments for subsequent surveys or additional gamified situational elements to guide the user toward providing more consistent career information. For example, it may take measures to improve the accuracy of the user's career information through additional surveys or feedback.

On the other hand, the specific point in time at which the survey is conducted may also be a moment when selectable career paths diverge from the accumulated career information.

For example, if a user shows strong interest and aptitude in the engineering field through tendency, aptitude, and preference surveys, the generative artificial intelligence model (200A) may create a branching point for selectable engineering-related majors or job fields at this point.

For instance, if a user responds that they prefer mathematical aptitude and theoretical learning, the generative artificial intelligence model (200A) may branch into various subfields of engineering (e.g., mechanical engineering, electrical engineering, computer engineering) based on this information.

The generative artificial intelligence model (200A) may design gamified situational elements to allow the user to explore various career paths at such branching points. For example, it may provide virtual projects or scenarios for each engineering field to help the user assess which field is more suitable.

Based on these branching points, following process of the survey may provide additional questions or scenarios tailored to each career path, helping the user gain a deeper understanding of their chosen career and select the optimal path.

Meanwhile, the generative artificial intelligence model (200A) described above may be at least one of a rule-based generation model, template-based generation model, story-based generation model, interactive generation model, or parameter-based generation model, but is not necessarily limited thereto.

In step S130, the processor (280) may provide gamified simulations to the user terminal (100) to test the user's ability to respond to each situation based on the gamified situational elements generated in step S120.

Through this, the user can solve problems and demonstrate their ability to handle job situations within the simulation.

More specifically, in step S130, the processor (280) can record and analyze the user's actions and choices in real-time as they participate in the simulation and solve given problems. For example, if a user interested in engineering participates in a “robot design and fabrication” simulation, the processor (280) can evaluate whether the user collaborates with a team, solves technical problems, and employs creative approaches.

In this process, the user's behaviors, such as problem-solving skills, collaboration abilities, and creative approaches demonstrated in the simulation, are stored as simulation results. Subsequently, the processor (280) can perform a verification process by comparing these simulation results with the user's accumulated career information. In other words, it determines whether the performance shown in the simulation aligns with the previously accumulated career information (e.g., tendencies, aptitudes, preferences).

For example, if the user demonstrates excellent problem-solving skills and strong team collaboration performance in the robot design simulation, the processor (280) can provide an analysis to the user terminal (100) indicating that the user is suitable for engineering fields, particularly roles requiring teamwork.

As such, in step S130, the processor (280) evaluates the user's career suitability by comparing simulation results with accumulated career information and can adjust or reinforce the career information as needed.

As another example, in step S130, the processor (280) can generate simulations based on gamified situational elements reflecting the user's tendencies, aptitudes, and preferences. For instance, if a user is highly interested in engineering and excels in problem-solving, the processor can create simulations incorporating engineering challenges.

Thus, the processor (280) can provide gamified simulations to the user terminal (100), enabling the user to engage in problem-solving within specific job situations. For example, the user may participate in a simulation themed around “smart home system design.” This simulation involves the user designing a virtual smart home project and solving related problems.

While the user engages in the simulation, the processor (280) can record the user's actions, decisions, and problem-solving approaches. These records are included in the simulation results and may contain data such as decisions on sensor placement or proposals for improving energy efficiency.

Accordingly, in step S130, the processor (280) can receive simulation results from the user terminal (100) and verify them by comparing them with the career information previously provided by the user (e.g., suitability for engineering).

For instance, the processor (280) can evaluate how well the simulation results align with the accumulated career information to verify the user's career suitability. For example, if the user effectively solves engineering problems in the simulation, this can confirm alignment with existing career information indicating high suitability for engineering.

Therefore, based on the alignment between simulation results and career information, the processor (280) can adjust or update the accumulated career information. If the simulation results do not align with the career information, the processor (280) can provide additional analysis or feedback to enhance the accuracy of the information.

Through this process, in step S130, the processor (280) analyzes the results of gamified simulations in real-time, verifies the accuracy of the user's career information, and provides personalized career advice, thereby enhancing the reliability of career exploration.

In step S140, the processor (280) can compose the following process of the survey based on verification results.

For example, if in step S130, the user demonstrated excellent performance in technical problem-solving, such as robot design, in a previous simulation and is highly likely to be suitable for engineering fields, the processor (280) in step S140 can add specific questions related to engineering to subsequent surveys based on these verification results. For instance, questions such as “Are you more interested in mechanical engineering or electrical engineering?” or “Do you feel stronger in software development or hardware design in robotics?” can be newly composed.

As such, in step S140, the processor (280) adjusts surveys to collect more detailed career-related information based on previous verification results, thereby supporting the user in exploring their career more accurately.

As another example, if in step S130, the user showed high performance in a creative problem-solving scenario related to arts in a previous simulation and is likely suitable for arts fields, particularly visual arts or design, the processor (280) in step S140 can add more specific questions related to arts to subsequent surveys based on these verification results. For example, questions such as “Are you more interested in graphic design or painting?” or “Do you prefer digital media or traditional media?” can be composed.

Thus, in step S140, the processor (280) composes surveys that reflect previous verification results, enabling more detailed and specific support for the user's career exploration, helping the user clearly understand and select their career path.

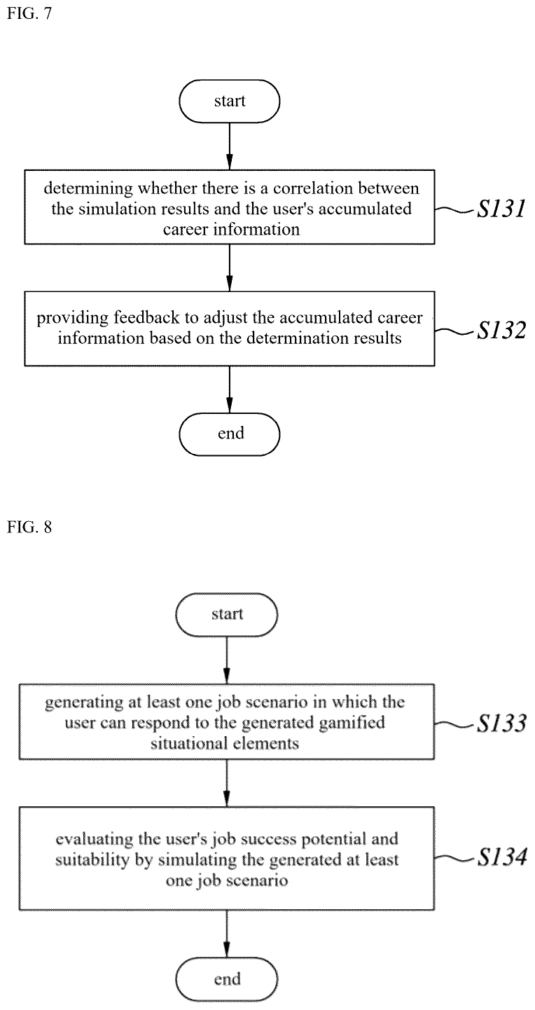

FIG. 7 is a flowchart illustrating a method for verifying a user's career information in step S130 through correlation analysis according to an embodiment of the present invention.

Referring to FIG. 7, the method of step S130 according to an embodiment, performed by the processor (280) of the career exploration server (200), may include steps S131 and S132.

In step S131, the processor (280) can determine whether there is a correlation between the results (performance) of the simulation obtained from the user terminal (100) and the accumulated career information.

For example, assuming a user participated in a simulation related to “mechanical engineering” and worked on a robot design project, the processor (280) can receive simulation results analyzing the user's problem-solving skills, design techniques, and collaboration abilities from the user terminal (100) and compare these results with the user's accumulated career information to determine the correlation.

At this point, for instance, if the user previously indicated high aptitude and preference for the “mechanical engineering” field in surveys, the simulation performance may be concluded to have a high correlation with this information. However, if the user struggled or showed poor performance during the mechanical engineering project simulation, the correlation analysis unit (231) may consider the possibility that the user may not be suitable for the mechanical engineering field.

Here, correlation analysis is a process of numerically evaluating the relationship between simulation results and the user's accumulated career information, using various specific metrics and scores to quantitatively assess the correlation.

For example, in step S131, the processor (280) can calculate the success rate of each task performed by the user in the simulation. The success rate is the ratio of the number of problems solved by the user to the total number of problems. For instance, if the user successfully solved 8 out of 10 problems in a robot design simulation, the processor (280) can calculate the success rate as 80%. This success rate can be compared with the user's accumulated career information to determine suitability for the mechanical engineering field.

Additionally, in step S131, the processor (280) can quantify the user's technical competencies in the simulation. For example, it can assign scores to the user's problem-solving skills, design techniques, and programming abilities, and calculate a technical suitability score by aggregating these scores.

For instance, if the user scores 85 points in problem-solving, 78 points in design techniques, and 80 points in collaboration, the processor (280) can use the average of these scores, 81 points, as the technical suitability score to evaluate suitability for the mechanical engineering field.

Furthermore, the processor (280) can evaluate the alignment between the user's simulation behavior and ideal behavior for the mechanical engineering field. For example, it can compare predefined ideal behavior patterns with the user's actual behavior to assign a score. If the career information verification unit (230) determines that the user demonstrates a 70% behavior alignment in the mechanical engineering simulation, this can indicate how well the user's behavior matches the expectations of the mechanical engineering field.

Accordingly, in step S131, the processor (280) can calculate a correlation metric by aggregating at least one of the success rate metric, technical suitability score, and behavior alignment score, as described above. The calculated correlation metric may numerically represent the degree of alignment between the user's simulation performance and accumulated career information.

For example, to evaluate suitability for the mechanical engineering field, if the success rate metric is 80%, the technical suitability score is 81 points, and the behavior alignment score is 70%, the processor (280) can calculate a correlation score by aggregating these metrics. If the correlation score is, for instance, 0.75 (75%), this may indicate a high correlation between the user's simulation performance and suitability for the mechanical engineering field.

Subsequently, in step S132, the processor (280) can provide feedback to the user terminal (100) based on the correlation analysis results derived in step S131 to adjust the user's accumulated career information.

For example, in step S132, if the correlation score is high, the processor (280) can provide positive feedback indicating that the user is suitable for the mechanical engineering field. If the score is low, it may suggest suitability for other fields.

For instance, if the correlation score is 0.75, indicating high suitability, the user receives feedback confirming their suitability for the mechanical engineering field. If the correlation score is low, such as 0.50, the user may be suggested possibilities in other engineering fields, such as electrical engineering or software engineering.

Such feedback guides the user to select a more suitable career path in the subsequent career exploration process and, if necessary, enables deeper analysis through additional simulations or surveys.

FIG. 8 is a flowchart specifically illustrating step S130 for simulating job scenarios to evaluate a user's job success potential and suitability according to an embodiment of the present invention.

Referring to FIG. 8, the method of step S130 according to an embodiment, performed by the processor (280) of the career exploration server (200), may further include steps S133 and S134.

In step S133, the processor (280) can generate at least one job scenario in which the user can respond to the various forms of situational elements generated in step S120.

For example, the processor (280) may generate a scenario requiring the user to implement a web application's functionality using a new programming language or complex algorithm for gamified situational elements related to technical challenges. It may also generate a scenario where the user collaborates with team members to develop software for gamified situational elements requiring teamwork. Additionally, it may generate a scenario where the user must complete a project within a specified deadline for gamified situational elements related to time management issues.

Subsequently, in step S134, when the job scenario generated in step S133 is a web application development project scenario, the processor (280) can obtain the results of simulating this web application development project scenario and evaluate, for example, the accuracy of the code, the completeness of function implementation, and the efficiency of the algorithm.

For instance, in step S134, the processor (280) can analyze errors in the written code to calculate the error rate relative to the total lines of code for evaluating code accuracy. For example, if 20 lines out of 1000 lines of code contain errors, the error rate is calculated as 2%. This rate can be used to assess code accuracy and assign a high accuracy score.

Additionally, in step S134, the processor (280) can test how well the implemented functions perform based on the scenario's requirements for evaluating the completeness of function implementation. The completeness of each function is evaluated on a scale from 0% to 100%. For example, if the user authentication function meets 90% of the requirements, the function completeness score is recorded as 90 points.

Furthermore, in step S134, the processor (280) can measure the algorithm's execution time and resource usage to assess efficiency for evaluating algorithm efficiency. For example, if the average execution time of an algorithm is measured as 5 seconds, an efficiency score of 80 points can be assigned based on this time. The efficiency score reflects optimized performance.

Accordingly, in step S134, the processor (280) can quantitatively evaluate the user's job success potential by aggregating these evaluation results. For example, it can calculate an average score from a code accuracy score of 90 points, a function completeness score of 85 points, and an algorithm efficiency score of 80 points, using this as the user's job suitability score.

As described above, each step, including the functional operations of the components described in various embodiments, may be implemented in the form of program instructions and recorded on a computer-readable recording medium and/or memory.

The aforementioned computer-readable recording medium may include program instructions, data files, data structures, or a combination thereof. The program instructions recorded on the computer-readable recording medium may be specially designed and configured for the present invention or may be known and available to those skilled in the computer software field. Examples of computer-readable recording media include magnetic media such as hard disks, floppy disks, and magnetic tapes; optical recording media such as CD-ROMs and DVDs; magneto-optical media such as floptical disks; and hardware devices specially configured to store and execute program instructions, such as ROM, RAM, and flash memory. Examples of program instructions include not only machine code generated by a compiler but also high-level language code executable by a computer using an interpreter. The hardware device may be configured to operate as one or more software modules to perform the processing according to the present invention, and vice versa.

Accordingly, although the present disclosure has been described with reference to specific details such as specific components in various embodiments and drawings, these are provided merely to facilitate a comprehensive understanding and are not limited to these embodiments. It is apparent to those skilled in the art that various modifications and variations can be made from these descriptions.

Therefore, the spirit of the present invention should not be limited to the embodiments described above. Not only the claims set forth below but also all equivalents or equivalent modifications thereof fall within the scope of the spirit of the present invention.

What is claimed is:

1. A method for exploring personalized career paths based on gamification by a career exploration server, the method comprising:
accumulating career information regarding at least one of a user's tendencies, aptitudes, and preferences in a stepwise manner through survey conducted in a pre-prepared question-and-answer format to support the user's career exploration;
generating, at a specific point in time during the survey, gamified situational elements related to career information that affects following process of the survey by a generative artificial intelligence model based on the accumulated career information;
providing a gamified simulation to test user's ability to respond to each situation based on the generated gamified situational elements, and verifying user's accumulated career information based on results of the gamified simulation; and
composing the following process of the survey based on verification results.

2. The method of claim 1, wherein verifying user's accumulated career information comprises:
determining whether there is a correlation between results of the gamified simulation and the user's accumulated career information; and
providing feedback to adjust the user's accumulated career information based on determination results.

3. The method of claim 1, wherein providing the gamified simulation comprises:
generating at least one job scenario in which the user can respond to the generated gamified situational elements; and
evaluating the user's job success potential and suitability by simulating the generated at least one job scenario.

4. The method of claim 1, wherein the specific point in time is a moment when inconsistencies arise among the accumulated career information or when career information misaligned with the user's tendencies is obtained.

5. The method of claim 1, wherein the specific point in time is as a branching point at which user's selectable career paths diverge based on the accumulated career information.
